(19) United States
(12) Patent Application Publication
(10) Pub. No.: US 2020/0406668 A1
(43) Pub. Date: Dec. 31, 2020

(54) THERMALLY INDUCED REVEALING DECORATIVE DEVICE

(71) Applicant: SV Kroma LLC, Walton Hills, OH (US)

(72) Inventors: Santosh Kanakkanatt, Akron, OH (US); Kevin Pachuta, Farmington, MI (US); Quinn Aiken, Cleveland, OH (US)

(21) Appl. No.: 16/913,499

(22) Filed: Jun. 26, 2020

Related U.S. Application Data
(60) Provisional application No. 62/867,514, filed on Jun. 27, 2019.

(51) Int. Cl. B44F 1/08; G02F 1/01; C11C 5/00

(52) U.S. Cl. CPC B44F 1/08; C11C 5/008; G02F 1/0147

(57) ABSTRACT

A thermally induced revealing decorative device has a non-opaque, or partially non-opaque, container with a matrix at least partially filling the container. A warming mechanism is used to heat this matrix, which has thermochromic properties, such that when sufficiently warmed it becomes transparent or translucent. At least one decorative item is located within, and completely encompassed by the matrix. When the matrix is cooled, it is opaque and the decorative item is hidden, but when the matrix is heated such that it becomes transparent/translucent, the decorative item is revealed.

This application claims the benefit of U.S. Provisional Application No. 62/867,514 filed Jun. 27, 2019.

### BACKGROUND

The present invention is in the field of decorative items, such as candles. More specifically this invention relates to a decorative item which reveals at least one hidden item or design when heated.

### SUMMARY OF INVENTION

A thermally induced revealing decorative device that can reveal decorative items or designs within a matrix through the change of temperature comprises a non-opaque container, a matrix at least partially filling the container, a warming mechanism for heating this matrix, and at least one decorative item or design located within, and completely encompassed by the matrix. The matrix has thermochromic properties, such that when sufficiently warmed it becomes transparent or translucent, thus revealing the decorative item encompassed within the matrix.

### BRIEF DESCRIPTION OF DRAWINGS

FIG. 1 is an isometric view of a thermally induced revealing decorative device according to an aspect of the invention.

FIG. 2 is a cross-section view from FIG. 1.

FIG. 3 is an exploded view of the cross-section of FIG. 2.

FIG. 4 is an isometric view of a thermally induced revealing decorative device according to an aspect of the invention.

FIG. 5 is an isometric view of a thermally induced revealing decorative device according to an aspect of the invention.

FIG. 6 is a cross-sectional view of FIG. 4.

FIG. 7 is an exploded view of a thermally induced decorative device, according to an aspect of the invention.

### DETAILED DESCRIPTION

Various aspects of the invention are presented in FIGS. 1-6 which are not drawn to scale and in which like components are numbered alike. Referring now to FIGS. 1-6, according to an aspect of the invention, a thermally induced revealing decorative device 10 is shown. According to an aspect of the invention, this device 10 comprises a non-opaque container 20, a matrix 30 at least partially filling the container 20, a warming mechanism 40 for heating this matrix 30, and at least one decorative item 50 located within, and completely encompassed by the matrix 30. The matrix 30 has thermochromic properties, such that when sufficiently warmed it becomes transparent or translucent, thus revealing the decorative item 50 encompassed within the matrix 30.

According to an aspect of the invention, the non-opaque container 20 is transparent tempered glass. Some other examples of materials that may be used for the non-opaque container 20 are etched or frosted glass, or plastic. The container needs to be non-opaque such that the decorative items within the matrix can be seen from outside the container when the matrix becomes translucent or transparent. As well, the container must be able to withstand thermal cycling, that is inherent to the reveal process, without any major degradation. The container may also be a combination of non-opaque and opaque, such as is shown in FIG. 7. The suggestions above are not a complete list of possible materials for the container 20, as any material having a non-opaque property and able to withstand the thermal cycling is considered within the purview of this invention.

According to an aspect of the invention, the matrix 30 is thermochromic wax, i.e. wax that changes color and transparency upon heating. An example of this type of thermochromic medium is disclosed in U.S. Pat. No. 6,165,234, which is herein incorporated by reference. Per the process described in U.S. Pat. No. 6,165,234, as the wax heats, it changes from a colored and opaque solid state to a colorless and translucent liquid state. Ideally this matrix 30 would initially almost fill the container 20, as an unburned candle would. As it is continually heated and cooled, the amount of matrix 30 may decrease due to volatilization. This matrix 30 may have a color when in a solid-state, but when heated such that the matrix changes to a liquid state, the color will disappear, and the matrix will be transparent or translucent.

According to a further aspect of the invention, the warming mechanism 40 is an external candle warmer or warming plate. Other examples of warming mechanisms 40 may be external light bulbs, external conductive rods, internal wicks, or internal conductive rods. This invention is not limited by the warming mechanisms listed herein, as any suitable mechanism that allows sufficient heating for the matrix 30 to undergo a change from a color opaque solid state to a colorless transparent liquid is considered within the purview of the invention.

According to an aspect of the invention, a minimum of one decorative item(s) 50 is to be totally encompassed within the matrix 30. When the matrix 30 is in a cooled and solid-state, the matrix 30 is opaque, and the decorative item 50 is not visible within the matrix 30. When the matrix 30 is sufficiently heated, the decorative item 50 is revealed and becomes visible due to a change of translucency and color of the surrounding matrix 30. An example of a decorative item 50 may be a miniaturized object such as baseball, baseball bat, soccer ball, or such if it was a sports themed decorative item. Other examples are miniaturized skulls, cross bones, witches, pumpkins or such if it was a Halloween themed decorative item. Any decorative item or items which are small enough to be contained within the container 20 and the matrix 30 may be included to fit any desired theme.

Since the matrix 30 changes from a solid to liquid state when heated, the decorative item(s) 50 may be held in place by having them laying on the container 20 bottom, where depending on the density of the decorative item, they may or may not need to be adhered to the container bottom. These items may also be suspended in place by physical means such as thin wire or rods if the items are to appear as ‘floating’ in the matrix. The items themselves may even be made of conductive materials such that current can be applied to heat the decorative object or wire holders and induce a change of state in the matrix immediately surrounding them, therefore heating the matrix 30 from the inside out.

According to an aspect of the invention the decorative item 50 may be a design element 52. This design element could be an image drawn or engraved on the inside bottom surface of the container, or an inside back wall of the container (see FIG. 7), such that it is seen when the matrix is transparent/translucent. It could also be something drawn or engraved on the inside wall of the double wall container described above.

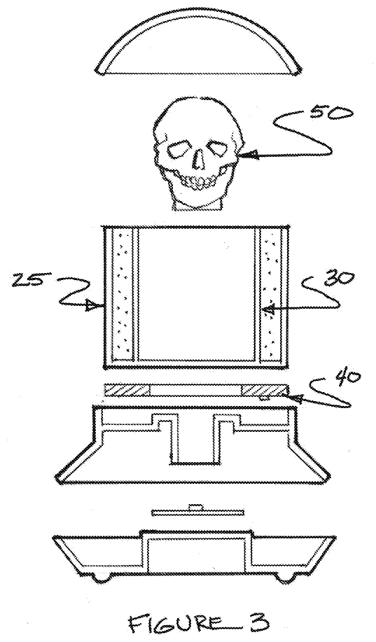

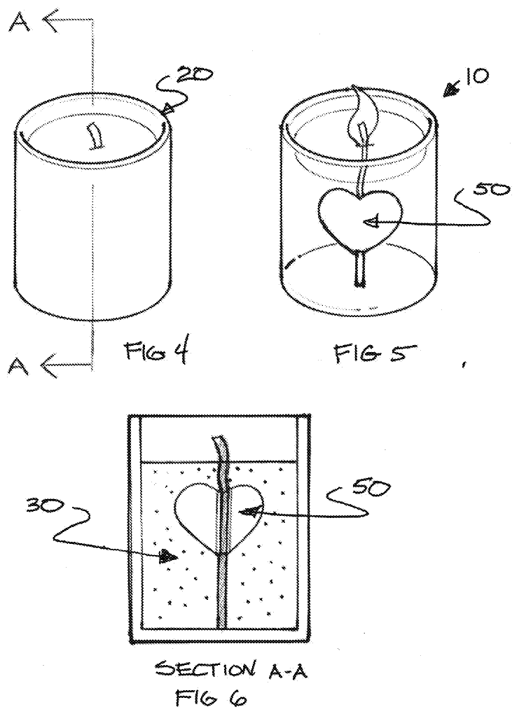

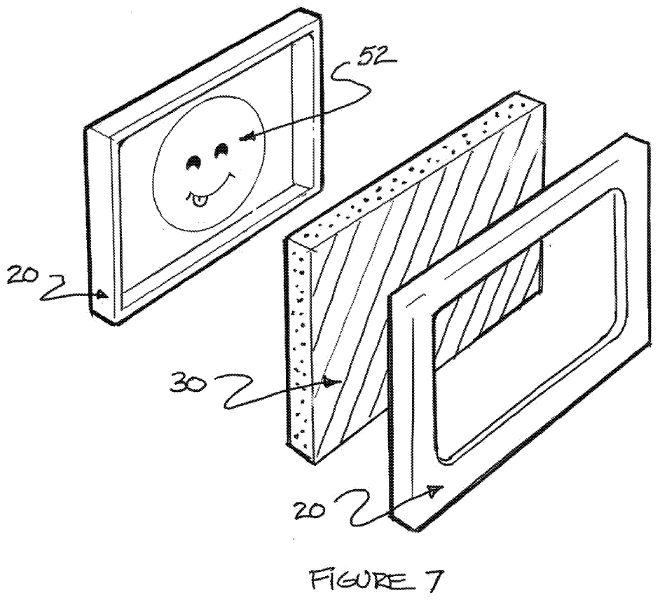

FIG. 4 shows a candle version of this invention, where the matrix 30 is a wax candle with a standard candle wick. FIG. 5 shows the candle lit, and the matrix heated sufficiently, such that the hidden item 50 is seen through the non-opaque container. FIG. 6 shows a cross-section of FIG. 4. In most cases the burning of the candle wick alone will not provide enough heat to change the entire matrix into the transparent/translucent state; some other warming mechanism such as discussed above must also be provided.

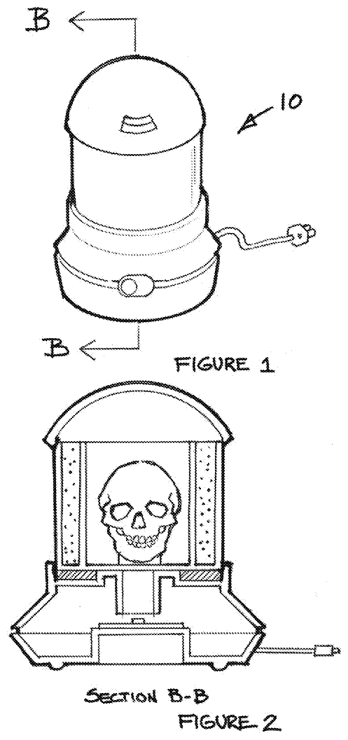

According to a further aspect of the invention, FIGS. 1 and 2 show an aspect of the invention wherein the non-opaque container 20 is a double wall container 25, and wherein the matrix 30 fills the space between these double walls. This allows the decorative item or items to not have to be submerged/covered by the matrix 30, but instead may just be placed in the open area inside the double-walled container.

I claim:

1. A thermally induced revealing decorative device comprising:
A non-opaque container;
A matrix at least partially filling said container, wherein said matrix has thermochromic properties, such that when warmed sufficiently said matrix becomes transparent or translucent;
A warming mechanism for heating said matrix;
At least one decorative item located in said container, and covered by said matrix, such that when said matrix is not transparent or translucent, said decorative item and/or design is not visible through the matrix, but when said matrix is heated sufficiently, said decorative item or design is visible through said matrix.

2. The thermally induced revealing decorative device of claim 1 wherein said matrix changes from a solid state to a liquid state upon heating.

3. The thermally induced revealing decorative device of claim 1 wherein said warming mechanism is an internal conductive rod.

4. The thermally induced revealing decorative device of claim 1 wherein said warming mechanism is an external warming plate.

5. The thermally induced revealing decorative device of claim 1 wherein said warming mechanism is an internal warming plate.

6. The thermally induced revealing decorative device of claim 1 wherein said decorative item is a design element drawn or engraved on the inside bottom of said container.

7. The thermally induced revealing decorative device of claim 1 wherein said decorative item is a design element drawn or engraved on an inside surface of said container.

8. A thermally induced revealing decorative device comprising:
A double-walled non-opaque container, having space between the double walls;
A matrix at least partially filling said space between said double walls of said double-walled container, wherein said matrix has thermochromic properties, such that when warmed sufficiently said matrix becomes transparent or translucent;
A warming mechanism for heating said matrix;
At least one decorative item located within said non-opaque container, such that when said matrix is not transparent or translucent, said decorative item and/or design is not visible in said container, but when said matrix is heated sufficiently, said decorative item and/or design is visible through said non-opaque container.

9. The thermally induced revealing decorative device of claim 8 wherein said matrix changes from a solid state to a liquid state upon heating.

10. The thermally induced revealing decorative device of claim 8 wherein said warming mechanism is an internal conductive rod.

11. The thermally induced revealing decorative device of claim 8 wherein said warming mechanism is an external warming plate.

12. The thermally induced revealing decorative device of claim 8 wherein said warming mechanism is an internal warming plate.

13. The thermally induced revealing decorative device of claim 8 wherein said decorative item is a design element drawn or engraved on an inside surface of said container.

14. The thermally induced revealing decorative device of claim 8 wherein said design is a drawing or engraving on the inside wall of said double-walled container.
